(19) United States
(12) Patent Application Publication
(10) Pub. No.: US 2007/0171261 A1
(43) Pub. Date: Jul. 26, 2007

(54) Array inkjet printhead

(75) Inventors: Nam-kyun Kim, Seongnam-si (KR); Jae-sik Min, Suwon-si (KR); Kwang-myeon Park, Yongin-si (KR); Eun-bong Han, Suwon-si (KR); Ju-hyun Lee, Hwaseong-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/586,536

(22) Filed: Oct. 26, 2006

(30) Foreign Application Priority Data
Jan. 24, 2006 (KR) 2006-7256

(51) Int. Cl. B41J 2/045

(52) U.S. Cl. 347/71

(57) ABSTRACT

An array inkjet printhead includes a substrate including an ink chamber to store ink to be ejected, a heater to apply heat to the ink, a TFT (thin film transistor) to control a voltage supplied to the heater, and a manifold to supply ink to the ink chamber, the ink chamber, the heater, and the TFT being formed in a top surface of the substrate, a nozzle plate formed on the substrate and including a plurality of nozzles through which the ink is ejected when the heater applies heat to the ink, and a driving unit to drive the TFT to make the heater generate the heat to eject the ink.

### CROSS-REFERENCE TO RELATED APPLICATIONS

This application claims priority under 35 U.S.C. §119(a) from Korean Patent Application No. 10-2006-0007256, filed on Jan. 24, 2006, in the Korean Intellectual Property Office, the disclosure of which is incorporated herein in its entirety by reference.

### BACKGROUND OF THE INVENTION

1. Field of the Invention

The present general inventive concept relates to an array inkjet printhead, and more particularly, to a bubble jet type array inkjet printhead.

2. Description of the Related Art

Inkjet printers eject ink using an ejecting mechanism, such as inkjet printheads, employing an electro-thermal transducer or an electromechanical transducer. In a method of ejecting ink using the electro-thermal transducer (a bubble jet method), bubbles are generated in ink using a heat source, and the ink is ejected by an expansion of the bubbles. In another method of ejecting ink using the electromechanical transducer, a piezoelectric material is deformed to apply a pressure to ink, and the ink is ejected by the pressure.

In a bubble jet type inkjet printer, a shuttle type printhead is spaced a predetermined distance from a top surface of a sheet of paper. The printhead forms an image on the sheet of paper by ejecting ink on the surface of the paper while reciprocating in a perpendicular direction to a feeding direction of the sheet of paper (i.e., the printhead reciprocates in the width direction of the sheet of paper). The shuttle type printhead includes a nozzle unit having a number of nozzles for ejecting ink.

In the shuttle type printhead, a current is selectively applied to a heater to generate bubbles in ink in a desired manner. Thus, ink can be selectively ejected by the expansion of the bubbles in order to form a desired image.

Unlike the shuttle type printhead, a recently-developed array printhead includes a nozzle unit having a length corresponding to the width of a sheet of paper in order to realize high-speed printing. Since the array printhead ejects ink on to a top surface of a feeding sheet of paper from a fixed position, the array printhead can print images at high speed using a simple driving unit.

The nozzle unit may be formed integrally with the array printhead and have a length corresponding to the width of the sheet of paper, or a plurality of head chips each having a nozzle unit may be attached to the array printhead.

In the former case, where the nozzle unit is as long as the width of the sheet of paper, it is difficult to manufacture the array printhead. Further, the nozzle unit is easily deformed and thus printing quality may be deteriorated.

In the latter case where a plurality of head chips each having a nozzle unit is attached to the array printhead, it is difficult to align the plurality of head chips. Further, the array printhead may have to be replaced even when one of the head chips is damaged, thereby increasing printing costs.

Furthermore, since each of the head chips may include a driving transistor, a logic circuit, a heater, and an ink chamber, the manufacturing cost increases in proportion to the number of head chips. In addition, although it takes more time to attach the plurality of head chips to the array printhead, the head chips are not precisely attached.

### SUMMARY OF THE INVENTION

The present general inventive concept provides an array inkjet printhead that may be manufactured by simultaneously forming a nozzle unit having a channel, a nozzle, a heater, and a TFT (thin film transistor) to drive the heater on a substrate and connecting a driving IC to drive the TFT to the array printhead.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an array inkjet printhead including a substrate including an ink chamber to store ink to be ejected, a heater to apply heat to the ink, a TFT (thin film transistor) to control a voltage supplied to the heater, and a manifold to supply ink to the ink chamber, the ink chamber, the heater, and the TFT being formed in a top surface of the substrate, a nozzle plate formed on the substrate and including a plurality of nozzles through which the ink is ejected when the heater applies the heat to the ink, and a driving unit to drive the TFT to make the heater generate the heat to eject the ink.

The foregoing and/or other aspects and utilities of the present general inventive concept may also be achieved by providing an array inkjet printhead including a nozzle plate having a length corresponding to a width of a sheet of paper and including a plurality of nozzle groups arranged in a zigzag pattern, the nozzle groups having a plurality of nozzle rows formed by a number of nozzles to eject ink, a substrate formed under the nozzle plate, the substrate including an ink chamber corresponding to each of the nozzles to store ink to be ejected, a heater to apply heat to the ink, a TFT to control a voltage supplied to the heater, and a manifold to supply ink to the ink chamber, the ink chamber, the heater, and the TFT being formed in a top surface of the substrate, and a driving unit to drive the TFT to make the heater generate heat to eject the ink.

The foregoing and/or other aspects and utilities of the present general inventive concept may also be achieved by providing an array inkjet printhead including a nozzle plate having a length corresponding to a width of a sheet of paper and including a plurality of nozzle groups arranged in a width direction of the nozzle plate, the nozzle groups having a plurality of nozzle rows formed by a number of nozzles arranged in a length direction of the nozzle plate to eject ink, a substrate formed under the nozzle plate, the substrate including an ink chamber corresponding to each of the nozzles and to store ink to be ejected, a heater to apply heat to the ink, a TFT to control a voltage supplied to the heater, and a manifold to supply ink to the ink chamber, the ink chamber, the heater, and the TFT being formed in a top surface of the substrate, and a driving unit to drive the TFT to make the heater generate the heat to eject the ink.

The foregoing and/or other aspects and utilities of the present general inventive concept may also be achieved by providing an array inkjet printhead apparatus including a substrate including a substrate layer, a chamber layer formed on a first portion of the substrate layer to form an ink chamber, a heater formed on the first portion of the substrate, and a TFT unit formed on a second portion of the substrate layer connected to the heater.

The foregoing and/or other aspects and utilities of the present general inventive concept may also be achieved by providing an array inkjet printhead apparatus including a substrate including a substrate layer, a chamber layer formed on a first portion of the substrate to form a plurality of lines of ink chambers in a first direction, a plurality of heaters formed to correspond to the ink chambers, and a TFT unit formed on a second portion of the substrate layer along the first direction, and having a plurality of transistors connected to corresponding ones of the heaters.

The foregoing and/or other aspects and utilities of the present general inventive concept may also be achieved by providing a method of manufacturing an array inkjet printhead, the method including forming a substrate including a substrate layer, a heater, an ink chamber, and a TFT unit.

The foregoing and/or other aspects and utilities of the present general inventive concept may also be achieved by providing a method of manufacturing an array inkjet printhead, the method including forming a substrate including a substrate layer, a plurality of ink chambers, a plurality of heaters, and a TFT unit.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view illustrating an inkjet printhead according to an embodiment of the present general inventive concept;

FIG. 2 illustrates a sectional view taken along line II-II′ of FIG. 1;

FIG. 3 illustrates a sectional view taken along line III-III′ of FIG. 1;

FIG. 4 illustrates a nozzle addressing structure of an inkjet printhead according to an embodiment of the present general inventive concept; and

FIG. 5 is a perspective view illustrating an inkjet printhead according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

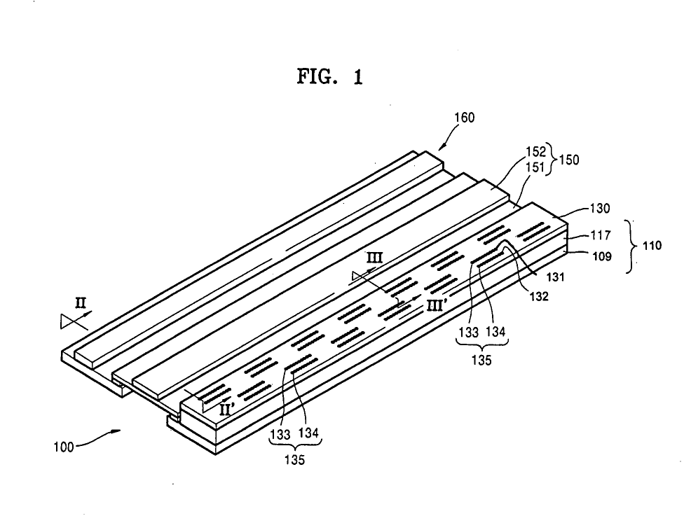

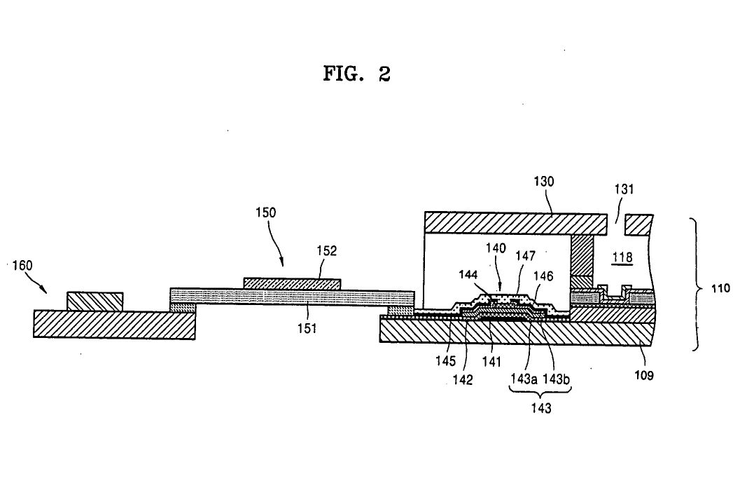

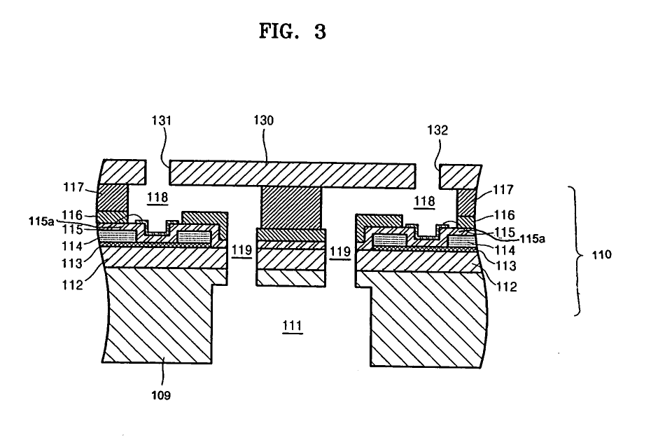

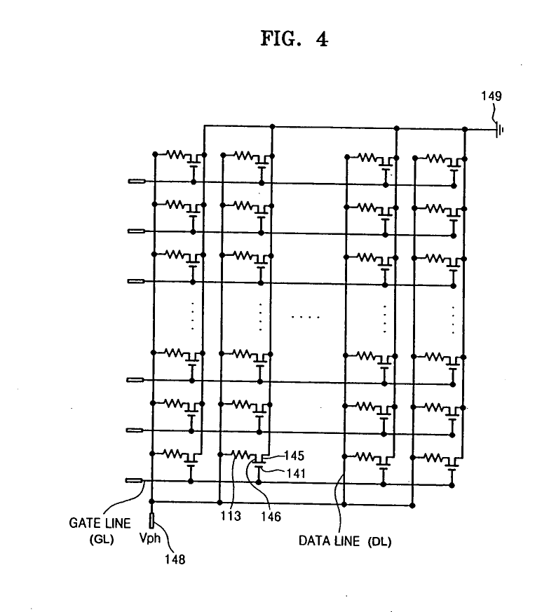

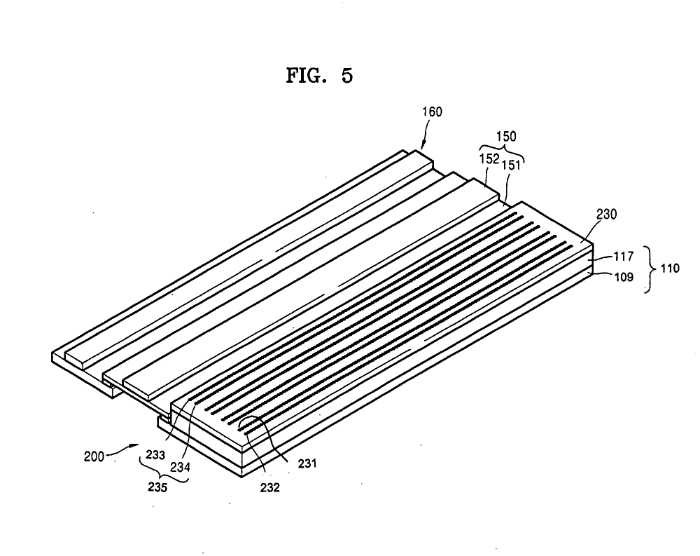

FIG. 1 is a perspective view illustrating an inkjet printhead 100 according to an embodiment of the present general inventive concept, FIG. 2 illustrates a sectional view taken along line II-II′ of FIG. 1, FIG. 3 illustrates a sectional view taken along line III-III′ of FIG. 1, FIG. 4 illustrates a nozzle addressing structure of an inkjet printhead according to an embodiment of the present general inventive concept, and FIG. 5 illustrates a perspective view of an inkjet printhead according to another embodiment of the present general inventive concept.

In the present general inventive concept, instead of individually manufacturing a plurality of inkjet head chips and attaching the individually manufactured inkjet head chips to an array inkjet printhead, nozzles and thin film transistors corresponding to the respective nozzles are integrally formed, and the thin film transistors are selectively operated to apply a voltage to corresponding heaters to eject ink through the nozzles.

Referring to FIGS. 1 through 3, the inkjet printhead 100 has a length corresponding to a width of a printing medium, such as a sheet of paper. The inkjet printhead 100 includes a substrate 110, a nozzle plate 130, and a driving unit 150.

The substrate 110 includes elements to eject ink through nozzles. In detail, the substrate 110 includes a heater 113 to generate heat, an electrode 114 formed on each side of the heater to apply a voltage to the heater 113, and an ink chamber 118 formed above the heater 113 and enclosed by a chamber layer 117 to store ink.

Reference numerals 112 and 116 denote insulating layers, and reference numerals 115 and 115a denote a plurality of passivation layers that may be included to prevent the heater 113 from making direct contact with the ink to protect the heater 113 from oxidation.

The substrate 110 further includes a manifold 111 formed therethrough on a substrate layer 109 to allow inflow of ink from an ink cartridge (not shown). A connecting path 119 is formed along one side of the heater 113 to connect the manifold 111 with the ink chamber 118, such that ink can flow from the manifold 111 into the ink chamber 118 through the connecting path 119.

A thin film transistor (TFT) 140 is formed on the substrate layer 109 at the other side of the heater 113. The TFT 140 controls an operation of the heater 113 by applying a voltage to the heater 113 or interrupting the voltage to the heater 113. The thin film transistor 140 has a similar structure to that of a thin film transistor for a conventional liquid crystal display (LCD). The heaters 113 are connected to corresponding ones of the gate lines GL and the data lines DL of the TFT 140.

A general structure of the thin film transistor 140 will now be described.

Referring to FIGS. 1 through 4, a metal having a low resistance is deposited on the substrate layer 109. Then, a plurality of gate lines GL (see FIG. 4) and a plurality of gate electrodes 141 may be formed on the deposited metal by photolithography. A gate insulating layer 142 is formed on the gate electrodes 141. A semiconductor layer 143 having an island shape is formed on a top surface of the gate insulating layer 142. The semiconductor layer 143 overlaps the gate electrodes 141. The semiconductor layer 143 may be formed by sequentially depositing an amorphous silicon layer (a-si) 143a and an ohmic contact layer (n+a-si) 143b. The ohmic contact layer 143b may be formed by ion-implanting an impurity into amorphous silicon.

A data line layer (see FIG. 4) may be formed by depositing a low-resistance metal layer above the semiconductor layer 143 and patterning the metal layer by photolithography. The data line layer includes a data line DL crossing the gate line GL and connected with the heater 113. The data line layer further includes a source electrode 145 and a drain electrode 146 that overlap an edge of the semiconductor layer 143. An insulation layer 144 is disposed on the semiconductor layer 143. A protection layer 147 may be formed on a top surface of the data line layer.

The nozzle plate 130 formed on the substrate 110 may include a plurality of nozzle groups 135 formed in a top surface in a length direction of the nozzle plate 130. The nozzle groups 135 may be arranged in a zigzag pattern as shown in FIG. 1. Each of the nozzle groups 135 includes a plurality of parallel nozzle rows 133 and 134 arranged in the length direction of the nozzle plate 130. The nozzle rows 133 and 134 include a plurality of nozzles 131 and 132, respectively. Therefore, the nozzles 131 and 132 of the nozzle rows 133 and 134 face each other.

Referring to FIG. 3, the ink chamber 118, the heater 113, and the electrode 114 are formed under each of the nozzles 131 and 132 of the nozzle rows 133 and 134. The ink chamber 118 is connected with the manifold 111 through the connecting path 119. Therefore, ink can flow from an ink cartridge (not shown) to each ink chamber 118 through the manifold 111 and the connecting path 119.

The gate lines GL and the data lines DL will now be described.

Referring to FIG. 4, although gate lines GL and data lines DL cross each other in a simple matrix format, the gate lines GL and the data lines DL may be arranged in correspondence with the nozzle groups 135 arranged in the zigzag pattern as shown in FIG. 1.

The gate lines GL are connected with all gate electrodes 141, and the data lines DL are connected with all drain electrodes 146 through corresponding ones of the heaters 113. The source electrode 145 is connected to a ground 149. The drain electrode 146 is connected with the heater 113, and the heater 113 is connected to a voltage (Vph) 148.

The drain electrode 146 is powered on and off by the driving unit 150. When the drain electrode 146 is powered off, the source electrode 145 and the drain electrode 146 are not electrically connected. Thus, the heater 113 does not receive a voltage.

When the drain electrode 146 is powered on, the source electrode 145 and the drain electrode 146 are electrically connected. Thus, the heater 113 receives a voltage to generate heat.

The source electrode 145 and the drain electrode 146 can be reversely arranged. That is, the source electrode 145 can be connected to the voltage 148 and the drain electrode can be connected to the ground 149.

The heater 113, the ink chamber 118, the nozzle 131, and the TFT 140 may be formed by an etching process using a photoresist. Since the etching process is well-known, a detailed description of the etching process will be omitted.

The driving unit 150 includes a driving IC 152 to control the TFT 140. The driving IC 152 may be connected with the TFT 140 through a connecting member 151 such as a tape carrier package (TCP), a tape automated bonding (TAB), or chip-on-glass (COG). The driving IC 152 and the TFT 140 may be electrically connected using a signal line of the connecting member 151.

The driving unit 150 and the TFT 140 may be separately fabricated and then bonded together as described above. The TFT 140 has a large width (about 2 μm) and the driving IC 152 has a small width (about 0.6 μm). Also, a power line connected to the voltage 148 has a large width. Thus, the driving unit 150 and the TFT 140 may be separately fabricated and then bonded together.

The driving unit 150 is connected to a main printed board assembly (PBA) 160 and may electrically communicate with the PBA 160 using a signal line there between.

Referring to FIG. 5, an inkjet printhead 200 is illustrated according to another embodiment of the present general inventive concept.

The inkjet printhead 200 has the same structure as the inkjet printhead 100 of FIG. 1 except that nozzles 231 and 232 formed in a nozzle plate 230 are arranged in a different manner. Thus, only the nozzles 231 and 232 will now be described.

In FIGS. 1 and 5, like reference numerals denote like elements.

Four nozzle groups 235 are sequentially arranged in a width direction of the inkjet printhead 200 (i.e., the nozzle groups 235 are sequentially arranged in a direction perpendicular to a length direction of the inkjet printhead 200). Each of the nozzle groups 235 includes two nozzle rows 233 and 234. The nozzle rows 233 and 234 include a plurality of nozzles 231 and 232, respectively, arranged in the length direction of the inkjet printhead 200. Therefore, the nozzles 231 and 232 of the nozzle rows 234 and 235 face each other. The heaters of the nozzles 231 and 232, of the respective nozzle rows 234 and 235, are connected to corresponding ones of the TFT 140.

As described above, the array inkjet printhead of the present general inventive concept has the following advantages.

First, instead of individually manufacturing a plurality of head chips and attaching the head chips to the array inkjet printhead, the nozzles and the corresponding TFTs may be directly formed in the array inkjet printhead. That is, the array inkjet printhead may be manufactured through a process similar to that for manufacturing an LCD panel. Therefore, the manufacturing cost of the array inkjet printhead may be reduced.

Second, in manufacturing the array inkjet printhead, the driving IC used to drive the TFT may be separately fabricated. Thus, manufacturing cost can be reduced.

Third, since head chips are not used, no alignment operation of the head chips is necessary, thereby reducing the manufacturing cost and time.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An array inkjet printhead apparatus comprising:
a substrate including a substrate layer, a chamber layer formed on a first portion of the substrate layer to form an ink chamber, a heater formed on the first portion of the substrate, and a TFT unit formed on a second portion of the substrate layer connected to the heater to control the heater.

2. The array inkjet printhead apparatus of claim 1, further comprising:
a driving unit connected to the second portion of the substrate layer to be electrically connected to the heater through the TFT unit.

3. The array inkjet printhead apparatus of claim 1, further comprising:
a nozzle unit formed on the substrate and having a nozzle to correspond to the ink chamber.

4. The array inkjet printhead apparatus of claim 3, wherein the nozzle unit extends to cover the TFT unit.

5. The array inkjet printhead apparatus of claim 3, wherein the nozzle unit comprises a first portion to correspond to the ink chamber, and a second portion to correspond to the TFT unit.

6. The array inkjet printhead apparatus of claim 1, wherein the first portion and the second portion are disposed on a same surface of the substrate layer.

7. The array inkjet printhead apparatus of claim 1, wherein the substrate further comprises a manifold to supply ink to the ink chamber formed on the first portion of the substrate layer.

8. The array inkjet printhead apparatus of claim 7, wherein the second portion of the substrate layer does not include the manifold.

9. The array inkjet printhead apparatus of claim 1, wherein the TFT unit comprises a gate electrode formed on the second portion of the substrate layer, a semiconductor layer formed on the gate electrode as a gate line, and a drain electrode formed over the semiconductor layer to be connected to the heater.

10. An array inkjet printhead apparatus comprising:
a substrate including a substrate layer, a chamber layer formed on a first portion of the substrate to form a plurality of lines of ink chambers in a first direction, a plurality of heaters formed to correspond to the ink chambers, and a TFT unit formed on a second portion of the substrate layer along the first direction, and having a plurality of transistors connected to corresponding ones of the heaters.

11. The array inkjet printer of claim 10, further comprising:
a nozzle unit having a first portion having a plurality of lines of nozzles to correspond to the respective ink chambers, and a second portion to correspond to the TFT unit.

12. The array inkjet printer of claim 10, wherein the chamber layer and the TFT unit are disposed in a second direction perpendicular to the first direction.

13. A method of manufacturing an array inkjet printhead comprising:
forming a substrate including a substrate layer, a heater, an ink chamber, and a TFT unit to control the heater in a single body.

14. The method of claim 13, wherein the substrate is formed by:
forming a heater on a first portion of a substrate layer;
forming a chamber layer on the first portion of the substrate layer to form an ink chamber; and
forming a TFT unit on a second portion of the substrate layer connected to the heater.

15. The method of claim 14, further comprising:
connecting a driving unit to the second portion of the substrate layer, to be electrically connected to the heater through the TFT unit.

16. The method of claim 13, further comprising:
forming a nozzle unit on the substrate having a nozzle corresponding to the ink chamber.

17. The method of claim 14, wherein forming the substrate further comprises:
forming a manifold on a first portion of the substrate layer to supply ink to the ink chamber.

18. The method of claim 13, wherein the TFT unit is formed by:
forming a gate electrode on the second portion of the substrate layer;
forming a semiconductor layer on the gate electrode as a gate line; and
forming a drain electrode over the semiconductor layer connected to the heater.

19. A method of manufacturing an array inkjet printhead comprising:
forming a substrate including a substrate layer, a plurality of ink chambers, a plurality of heaters, and a TFT unit.

20. The method of claim 19, wherein the substrate is formed by:
forming a chamber layer on a first portion of the substrate layer to form a plurality of lines of ink chambers in a first direction;
forming a plurality of heaters corresponding to the ink chambers; and
forming a TFT unit on a second portion of the substrate layer along the first direction, and having a plurality of transistors connected to corresponding ones of the heaters.

21. The method of claim 19, further comprising:
forming a nozzle unit on the substrate having a first portion having a plurality of lines of nozzles corresponding to the respective ink chambers, and a second portion to correspond to the TFT unit.
